(19) United States
(12) Patent Application Publication
(10) Pub. No.: US 2009/0198677 A1
(43) Pub. Date: Aug. 6, 2009

(54) Document Comparison Method And Apparatus

(75) Inventors: Edward Sheehy, Willoughby (AU); David Sitsky, Centennial Park (AU); Daniel Noll, Marrickville (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Nuix Pty.Ltd., Ultimo (AU)

(21) Appl. No.: 12/334,357

(22) Filed: Dec. 12, 2008

Related U.S. Application Data
(60) Provisional application No. 61/063,757, filed on Feb. 5, 2008.

(30) Foreign Application Priority Data
Feb. 5, 2008 (AU) 2008900543

(51) Int. Cl. G06F 17/30

(52) U.S. Cl. 707/5; 707/E17.014

(57) ABSTRACT

A document comparison and identification method comprises the steps of: identifying (S210), in a source document, words of a predetermined number of characters or greater; generating a list containing the identified words (S220), and excluding (S220) identified words occurring with a predetermined frequency or greater throughout a set of documents to be searched; searching (S230) each of the plurality of documents in the set of documents for occurrences of the identified words stored in the list; for each of the plurality of documents, determining (S230) how many identified words from the list occur in the document; and calculating (S240) a similarity of each of the plurality of documents to the source document based on the total number of identified words in the list, the number of identified words in the list occurring in the document, and a predetermined minimum required number of matches.

### RELATED APPLICATIONS

The present application claims priority from U.S. Provisional Patent Application No. 61/063,757 filed on 5 Feb. 2008 and Australian Provisional Patent Application No. 2008900543 filed on 5 Feb. 2008. The entire disclosure of U.S. Provisional Patent Application No. 61/063,757 and Australian Provisional Patent Application No. 2008900543 are incorporated herein by reference.

### TECHNICAL FIELD

The present invention relates generally to the comparison of documents, and in particular, to the comparison of documents for identifying documents which are similar to a source document.

### BACKGROUND

Document comparison and identification is commonly used for electronic discovery purposes to identify documents relevant to a particular issue, and to trace the movements of these documents. Due to the often large data sets involved, it is impossible to manually compare and identify each of the documents of the data set. Automated data culling techniques have therefore been developed to create a smaller sub-set of the large data set of documents, which sub-set can then be manually reviewed. Among the known data culling techniques are deduplication, near-deduplication, keyword searching, and file extension searching.

Deduplication identifies and groups files that are identical to each other. Deduplication techniques involve the use of hashing to create hash values for each document in the data set. The mathematical algorithms used in hashing ensure, with a large probability, that each hash value will be unique to a document. Two or more documents having the same hash value can hence be determined to be identical copies of each other. Deduplication techniques may, for example, employ MD5 hashes. An MD5 hash is calculated for each document in a data set, and the MD5 hashes of each document are compared to locate identical documents.

Near-deduplication attempts to identify similar documents by searching the contents of documents for documents containing similar words, and/or similar placement of words.

Keyword searching involves searching the contents of documents for the existence or absence of predetermined keywords. Advance keyword searching techniques allow for the collocation of words, wildcards, and the like, to be considered.

File extension searching involves searching for files of a certain extension, assuming that the extensions are representative of the file format.

The above methods suffer from a number of deficiencies however. Deduplication, for example, only locates identical documents. Documents of the same literary content but saved in different formats, for example, would not be found by a deduplication method. Different versions of a document, such as draft versions, revisions, final versions, and so forth, would also not be found by a deduplication search.

Near-deduplication, on the other hand, whilst able to some extent to identify documents of similar content, is limited to text documents. Non-text documents such as MPEG or Audio files, TIFF and non-searchable PDF versions of text files hence cannot be identified.

Keyword searching tends to return a large number of irrelevant documents, or too few documents if the keywords used are too restrictive. Keyword searching further determines the similarity of documents based predominantly on the number of keywords matched, which is not always the best indication of similarity, particularly if searching documents in the same subject area, industry, from the same organisation, and the like. The effectiveness of keyword searching is also very much dependent on the skill of the searcher.

File extension searching returns files of the same extension, the number of which is often still prohibitively large. Furthermore, file extension searching is based on the unreliable assumption that a file's extension is indicative of the format of the file and the general content of the file (e.g. text, graphic, video, etc). Moreover, some file systems do not require files to have extensions.

None of the above techniques offer a sufficient measure of confidence to a user that substantially all relevant documents have been found, without at the same time returning a large number of documents that each have to be manually reviewed. A technique that could identify not just identical documents, but also similar and relevant documents such as various revisions of the same document, different formats of the same document, and the like, would be particularly advantageous.

### SUMMARY

According to an aspect of the present invention, there is provided a document comparison and identification method. The method comprises the steps of: identifying, in a source document, words of a predetermined number of characters or greater; generating a list containing the identified words, and excluding identified words occurring with a predetermined frequency or greater throughout a set of documents to be searched; searching each of the plurality of documents in the set of documents for occurrences of the identified words stored in the list; for each of the plurality of documents, determining how many identified words from the list occur in the document; and calculating a similarity of each of the plurality of documents to the source document based on the total number of identified words in the list, the number of identified words in the list occurring in the document, and a predetermined minimum required number of matches.

According to another aspect of the present invention, there is provided a document comparison and identification method that comprises the steps of: performing a first search to identify documents identical to a source document; performing a second search to identify documents having an identical or a similar document name to the source document; performing a third search to identify documents of similar content to the source document; determining a ranking for the results of each of the first, second, and third searches; and presenting results of the first, second, and third searches in accordance with the determined ranking.

According to another aspect of the present invention, there is provided a document comparison and identification apparatus comprising: a memory unit for storing data and program instructions; and a processing unit coupled to the memory unit. The processing unit is programmed to: identify, in a source document, words of a predetermined number of characters or greater; generate a list containing the identified words, and exclude identified words from the list that occur with a predetermined frequency or greater in a set of documents to be searched; search each of the plurality of documents in the set of documents for occurrences of the identified words stored in the list; determine, for each of the plurality of documents, how many identified words from the list occur in the document; and calculate a similarity of each of the plurality of documents to the source document based on the total number of identified words in the list, the number of identified words in the list occurring in the document, and a predetermined minimum required number of matches

According to another aspect of the present invention, there is provided a document comparison and identification apparatus, comprising: a memory unit for storing data and program instructions; and a processing unit coupled to the memory unit. The processing unit is programmed to: perform a first search to identify documents identical to a source document; perform a second search to identify documents having an identical or a similar document name to the source document; perform a third search to identify documents of similar content to the source document; determine a ranking for the results of each of the first, second, and third searches; and present results of the first, second, and third searches in accordance with the determined ranking.

According to another aspect of the present invention, there is provided a computer program product comprising a computer readable medium comprising a computer program recorded therein for document comparison and identification. The computer program product comprises: computer program code means for identifying, in a source document, words of a predetermined number of characters or greater; computer program code means for generating a list containing the identified words, and excluding identified words from the list that occur with a predetermined frequency or greater in a set of documents to be searched; computer program code means for searching each of the plurality of documents in the set of documents for occurrences of the identified words stored in the list; computer program code means for, for each of the plurality of documents, determining how many identified words from the list occur in the document; and computer program code means for calculating a similarity of each of the plurality of documents to the source document based on the total number of identified words in the list, the number of identified words in the list occurring in the document, and a predetermined minimum required number of matches.

According to another aspect of the present invention, there is provided a computer program product comprising a computer readable medium comprising a computer program recorded therein for document comparison and identification. The computer program product comprises: computer program code means for performing a first search to identify documents identical to a source document; computer program code means for performing a second search to identify documents having an identical or a similar document name to the source document; computer program code means for performing a third search to identify documents of similar content to the source document; computer program code means for determining a ranking for the results of each of the first, second, and third searches; and presenting results of the first, second, and third searches in accordance with the determined ranking.

### BRIEF DESCRIPTION OF THE DRAWINGS

Aspects the present disclosure are described with reference to the following drawings:

FIG. 1 is a flow chart illustrating a method according to an aspect the present disclosure.

FIG. 2 is a flow chart illustrating a search function according to an aspect of the present disclosure.

FIG. 3 illustrates an event map according to an aspect of the present disclosure.

FIG. 4 illustrates an event map according to another aspect of the present disclosure.

FIG. 5 is a schematic block diagram of a computer system suitable for implementing methods of the present disclosure.

### DETAILED DESCRIPTION

Disclosed herein is a document comparison method and apparatus for identifying documents matching search criteria, and ranking documents based on their similarity to the search criteria. The search criteria may, for example, comprise one or more of a user inputted item of information such as a keyword, date, name, and the like, or may be another document. As used herein, the term document refers to computer readable files in general and include, for example, text documents, graphic files, video files, emails, music files, binary files in general, and the like.

According to an embodiment in the present disclosure, one or more documents are provided as an input. Typically, this input is an archive file or set containing a plurality of documents therein. Examples of such archive files include, but are not limited to, Microsoft™ Outlook PST files, Microsoft™ Exchange Server EDB files, Lotus™ Notes NSF files, and the like. The archive file is processed, and a database or other index comprising an organized representation of the whole or partial contents of the archive file, characteristics and other relevant information of the contents of the archive file, and the like, is created. The database is used to effect comparison and identification of the documents contained in the archive file, and searching of the contents of the archive file in general.

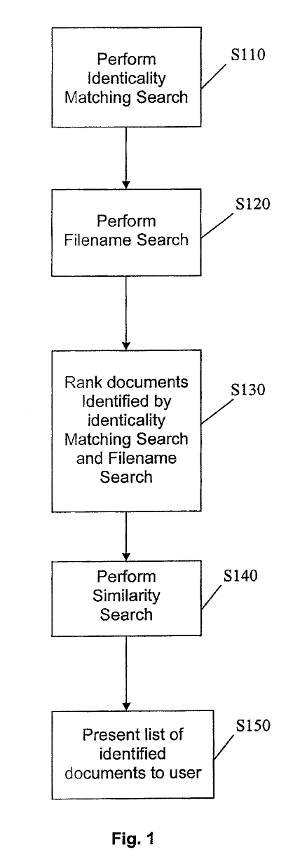

A first aspect of the present disclosure is described with reference to FIG. 1. In the first aspect of the present disclosure, three search methods are utilized in combination to identify documents in an archive file that are similar to a source document. The source document may be initially identified, for example, by a keyword search and the like, or by user selection. The source document may itself be in a document in the archive file or set of documents. As used herein, the phrase “similar documents” includes documents which are identical. A database or other index representative of the archive file may be created prior to performing the following steps.

At step S110, a first search performs an identicality matching search on the archive file or database for documents matching the source document. This search utilizes techniques such as MD5 hashing techniques to identify documents that are bit wise identical to the source document. Documents that may have different file names, but are otherwise identical in content, will be identified as identical by the identicality matching search.

At step S120, a second search is performed on the archive file or database to identify documents that have the same or a similar document name as that of the source document.

At step S130, documents identified by either or both of the searches performed in steps S110 and S120 are considered to be similar to the source document and are assigned a similarity ranking of ‘High’.

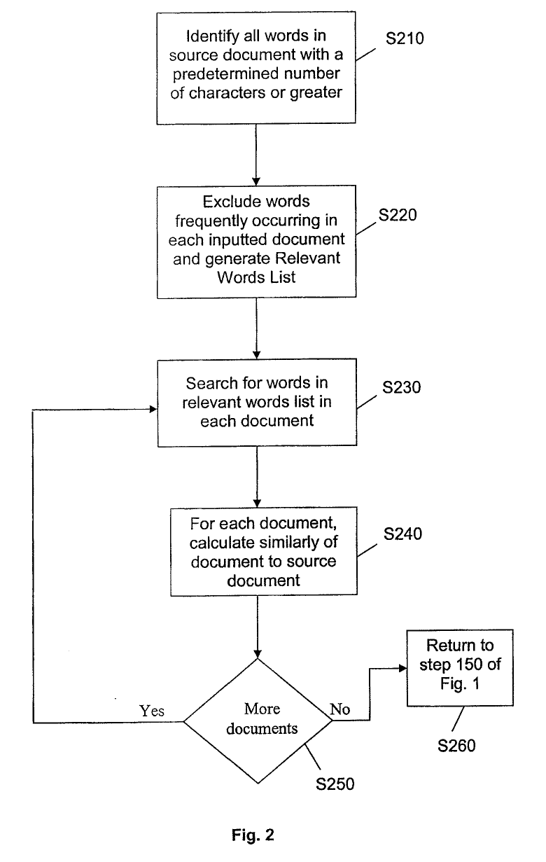

At step S140, a third search function performs a similarity search to locate documents in the archive file which are similar in content to the source document. The similarity search is based on the contents of the documents in the archive file. The similarity search is described in greater detail hereinafter with reference to FIG. 2.

Referring to FIG. 2, at step S210, all words in the source document having at least a predetermined number of characters are identified. The predetermined number of characters may be for example 6. It is to be understood, however, that the number of characters may be more or less than 6 in alternative embodiments of the present disclosure.

At step S220, of the identified words having 6 or more characters, words that appear with a predetermined frequency or greater throughout the archive file are disregarded/excluded. The remaining list of identified words forms a Relevant Word List. The total number of words in the Relevant Word List is denoted by T. The predetermined frequency may be determined according to a tf-idf (term frequency—inverse document frequency) weight, for example.

At step S230, the relevant words contained in the Relevant Word List are searched for in each document in the archive file. The number of relevant words appearing in a particular document is denoted by Y.

Whether a document is similar, and/or how similar the document is, is determined at step S240 in accordance with a number of matching relevant words Y found in the document, a minimum required number of matches M, a similarity ranking X, and a constant coefficient N. The minimum required number of matches M for a given similarity X is determined as follows:
For a source document

where T≦N: M=T

For a source document M=Floor (((T−N)*X)+N)

where T>N:

where:
X=0.9, for ‘High’ similarity;
X=0.7, for ‘Medium’ similarity; and
X=0.5, for ‘Low’ similarity.

The inventors have found that a value of N=5 is preferable.

The document has:
‘High’ similarity if: Y≧M when X=0.9
‘Medium’ similarity if: Y≧M when X=0.7
‘Low’ similarity if: Y≧M when X=0.5
Not considered similar if: Y<M when X=0.5

Steps S230 to S240 are repeated, at step S250, until all documents in the archive file have been considered or processed.

It should be noted that for an archive file for which a database or index representative of the archive file has been created, the iteration of steps S230 to S250 may be replaced by a single step of querying the database/index for documents containing M relevant words. In this case, steps S230 to S250 of FIG. 2 may represent a logical process rather than an actual process taken. As a query of a database/index is significantly faster than an iterative process that iterates through each document of an archive file, it is preferable that the searching of the relevant words is effected by a query.

When all the documents in the archive file have been considered, at step S250, processing returns to step S150 of FIG. 1.

Returning to FIG. 1, a list of documents having ‘High’, ‘Medium’, and ‘Low’ similarity as determined by the three searching methods is presented to the user at step S150. The list, and other information associated with the contents of the list, may be presented to the user graphically as described hereinafter. By ranking the results of the search/s, and by incorporating documents of ‘Low’ similarity in the results of the search, a user is able to identify the point/document at which the results of the search become irrelevant. Confidence that substantially all the relevant documents have been located/identified in the search may thereby be instilled in the user.

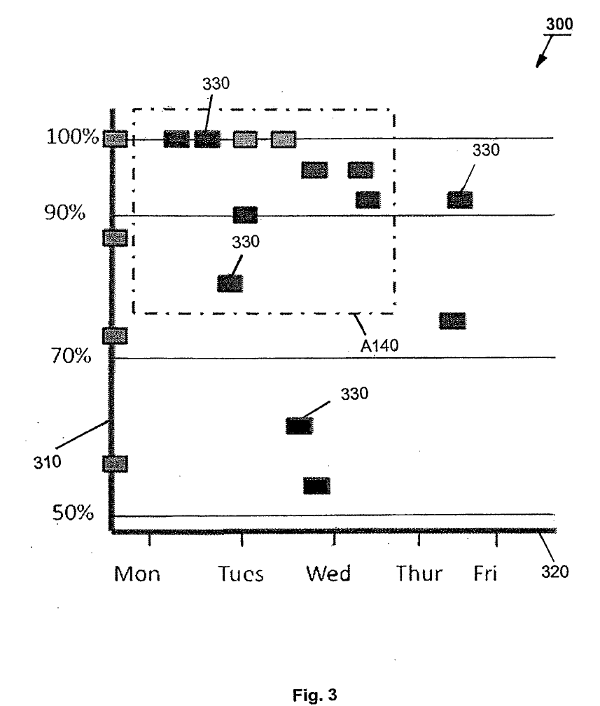

FIG. 3 illustrates a Document Similarity event map 300 according to another aspect of the present disclosure. For example, a Document Similarity event map such as the Document Similarity event map 300 of FIG. 3 may be presented to the user in step S150 of FIG. 1. Referring to FIG. 3, the vertical axis 310 indicates a measure of similarity of documents identified by the search/e described hereinabove. The horizontal axis 320 indicates, for example, a time and date associated with the identified documents. Further examples include, but are not limited to: a date of sending a parent email message, an author of a document, the last modification date of a document, a creation date of a document, and the like. The indication of the horizontal axis 320 is preferably user configurable.

Each identified document is denoted on the event map by an indicia 330, for example a dot or rectangle. Preferably, the indicia 330 are colour coded to facilitate interpretation of the event map. For example, identified documents having an exact MD5 match and file name match may be displayed by red indicia, while identified documents having an exact MD5 match but with a different file name may be displayed by pink indicia. A further colour may be used to identify documents of the same content but of different format, while yet a further set of colours may be used to identify documents of a certain similarity (e.g., blue for high similarity, purple for medium similarity, etc.).

The event map 300 is preferably interactive such that a user may perform a drill down action on the event map 300 to obtain more detailed information. For example, an indicia may be double clicked (e.g., using a computer pointing device) to display the document represented by the indicia, the document's chain of custody, attachments, metadata, and the like. Additionally, a user may also click an indicia of a certain colour to perform a process on all indicia of the same colour, such as to list all documents of the same similarity, export such documents, and the like.

A selection box A140 may be generated (e.g., by a user) on the event map 300 to obtain detailed information on the documents represented by the indicia within the selection box A140, or to perform processes thereon. Such processes may, for example, include an export process, review process, listing, and the like.

The event map 300 is not limited to a 2-dimensional graphical representation as shown in FIG. 3 and may, for example, comprise a 3-dimensional graphical representation, and/or may be displayed as cluster circles, x-y scatter dots, bar graphs, and the like, and/or a combination of the above.

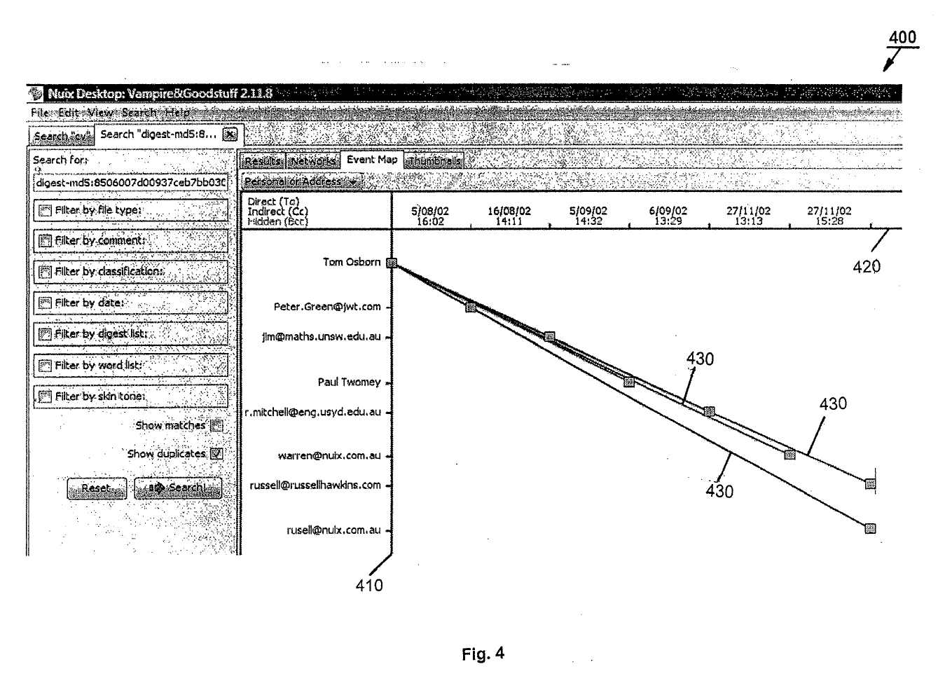

FIG. 4 illustrates an event map 400 according to a further aspect of the present disclosure. For example, an event map such as the event map 400 of FIG. 4 may be presented to the user in step S150 of FIG. 1. Referring to FIG. 4, the event map 400 graphically illustrates the movement of a document, and documents similar thereto. The vertical axis 410 of the event map 400 indicates a sender or recipient of a document. The horizontal axis 420 indicates the date on which a document was sent. The event map 400 illustrates a scenario where six similar documents were sent to seven different people. The communication of the documents to the seven people is indicated by the lines 430. Seven lines 430 are present in the event map 400, though only four of the seven lines 430 are readily identifiable in FIG. 4 due to a number of the lines 430 overlapping each other. The lines 430 are preferably colour coded to facilitate understanding. For example, direct mail may be indicated by a red line, while CC mail may be indicated by a blue line and BCC mail may be indicated by a green line.

An embodiment of the present invention provides a document comparison and identification method comprising the steps of: identifying, in a source document, words of a predetermined number of characters or greater; generating a list containing the identified words, and excluding identified words from the list that occur with a predetermined frequency or greater in a set of documents to be searched; searching each of the plurality of documents in the set of documents for occurrences of the identified words stored in the list; for each of the plurality of documents, determining how many identified words from the list occur in the document; and calculating a similarity of each of the plurality of documents to the source document based on the total number of identified words in the list, the number of identified words in the list occurring in the document, and a predetermined minimum required number of matches.

The predetermined number of characters may be 6. The predetermined minimum required number of matches may be calculated according to the formula:

M=Floor (((T−N)*X)+N)
wherein:
M is the minimum required number of matches;
T is the number of words in the list;
N is a constant coefficient;
X is a similarity ranking value; and
the number of identified words in the list is less than or equal to the constant coefficient.

A document may be determined to have high similarity with the source document if the number of identified words in the list occurring in the document is greater than, or equal to, the predetermined minimum required number of matches when X=0.9. Furthermore, a document may be determined to have medium similarity with the source document if the number of identified words in the list occurring in the document is greater than, or equal to, the predetermined minimum required number of matches when X=0.7. Furthermore, a document may be determined to have low similarity with the source document if the number of identified words in the list occurring in the document is greater than, or equal to, the predetermined minimum required number of matches when X=0.5. Furthermore, a document may be determined not to be similar to the source document if the number of identified words in the list occurring in the document is less than the predetermined minimum required number of matches when X=0.5. The predetermined minimum required number of matches may be determined to be equal to the number of identified words in the list.

An embodiment of the present invention provides a document comparison and identification method comprising the steps of: performing a first search to identify documents identical to a source document; performing a second search to identify documents having an identical or a similar document name to the source document; performing a third search to identify documents of similar content to the source document; determining a ranking for the results of each of the first, second, and third searches; and presenting results of the first, second, and third searches in accordance with the determined ranking. The documents identified by the first and second searches may be deemed to have a high similarity ranking. The third search may be performed in accordance with a document comparison and identification method described hereinbefore and specifically with the embodiment of the document comparison and identification method described immediately hereinbefore.

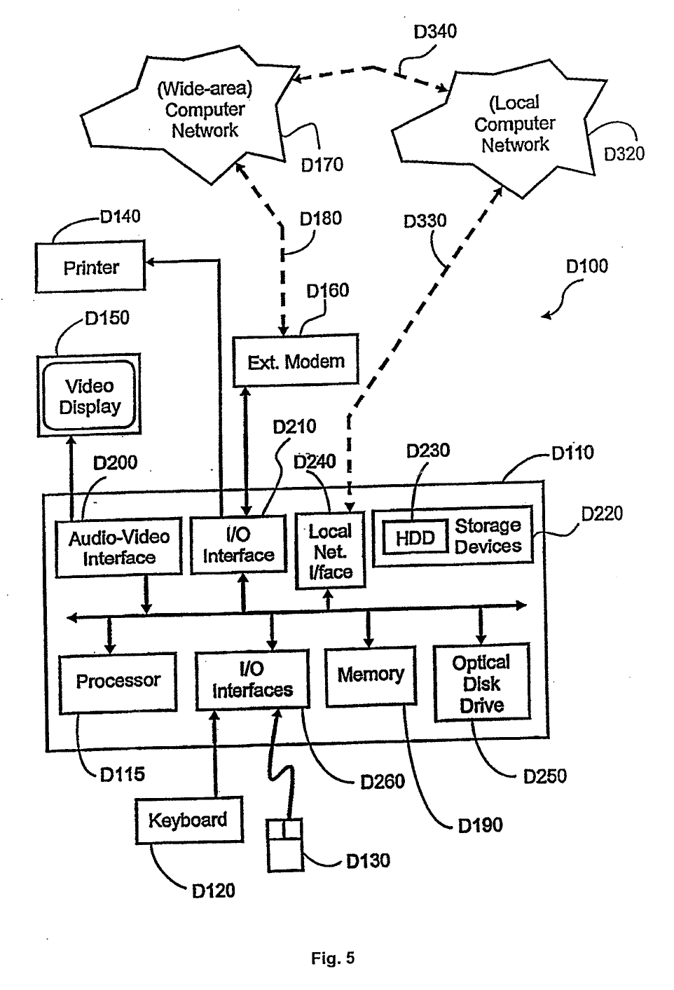

The document comparison methods described hereinbefore may be implemented using a computer system, such as the computer system described hereinafter with reference to FIG. 5. For example, the steps of the methods described hereinbefore with reference to FIGS. 1 and 2 may be implemented using the computer system D100 of FIG. 5.

As shown in FIG. 5 the computer system D100 is formed by a computer module D110, input devices such as a keyboard D120 and a mouse pointer device D130, and output devices such as a printer D140, and a display device D150. A modem device D160 may be used by the computer module D110 for communicating to and from a communications network D170 via a connection D180 to, for example, receive an archive file as input and/or access a network database. The network D170 may be a wide-area network (WAN), such as the Internet or a private WAN.

The computer module D110 typically includes at least one processor unit D115, and a memory unit D190, for example formed from semiconductor random access memory (RAM) and read only memory (ROM). The module D110 also includes a number of input/output (I/O) interfaces including an audio-video interface D200 that couples to the video display D150, an I/O interface D260 for the keyboard D120 and mouse D130, and an interface D210 for the external modem D160 and printer D140. The computer module D110 may also have a local network interface D240 which, via a connection D330, permits coupling of the computer system D100 to a local computer network D320. As also illustrated, the local network D320 may also couple to the wide network D170 via a connection D340. The interface D240 may be formed by an Ethernet™ circuit card, a wireless Bluetooth™ or an IEEE 802.11 wireless arrangement, and the like.

Storage devices D220 are provided and typically include a hard disk drive D230 and an optical disk drive D250.

The steps of the methods described hereinbefore may be implemented as software, such as one or more application programs executable within the computer system D100. In particular, the steps of the methods described hereinbefore with reference to FIGS. 1 and 2 may be effected by instructions in software. The instructions may be formed as one or more code modules, each for performing one or more particular tasks. The software may also be divided into two separate parts, in which a first part and corresponding code modules perform the document comparison method, and a second part and corresponding code modules manages a user interface between the first part and the user, such as to generate and present an event map to the user. The software may be stored in a computer readable medium and loaded into the computer system D100 from the computer readable medium, and then executed by the computer system D100.

In executing the software instructing the computer system D100 to perform one or more of the steps illustrated in FIGS. 1 and 2, and as hereinbefore described, the computer system D100 and its relevant components effect various means for performing one or more of the steps. The execution of the software in the computer system D100 also effects a document comparison apparatus for identifying documents matching a search criteria, and ranking documents based on their similarity to the search criteria.

According to one or more aspects of the present disclosure, a number of different search methods are employed in combination. In employing a number of different search methods in combination, a more comprehensive search may be performed. For example, similar documents may be identified by having identical or similar document names, or identical MD5 hash values. This is particularly effective when searching non-text documents. When searching text documents, the hereinbefore described similarity search may also be employed to identify similar documents. In contrast, searches employing only near-deduplication or keyword searching, for example, are able to search only text documents, while searches employing only deduplication searches such as those involving hashing techniques are unable to identify documents of similar literary content.

Moreover, conventional search techniques such a deduplication and near-deduplication are generally utilized to exclude documents. In contrast, the document comparison methods of the present disclosure may be used to identify documents similar to a given relevant document.

Additionally, by ranking identified documents, for example with High, Medium, and Low rankings, confidence that substantially all relevant documents have been located/identified in a search can be instilled in a user. Further, by graphically representing the similarity of documents, relevant documents can be easily identified and selected for review.

The foregoing describes only some embodiments of the present invention, and modifications and/or changes can be made thereto without departing from the scope and spirit of the invention, the embodiments being illustrative and not restrictive.

1. A document comparison and identification method, the method comprising the steps of:
identifying, in a source document, words of a predetermined number of characters or greater;
generating a list containing the identified words, and excluding identified words from said list that occur with a predetermined frequency or greater in a set of documents to be searched;
searching each of the plurality of documents in the set of documents for occurrences of the identified words stored in the list;
for each of the plurality of documents, determining how many identified words from the list occur in the document; and
calculating a similarity of each of the plurality of documents to the source document based on the total number of identified words in the list, the number of identified words in the list occurring in the document, and a predetermined minimum required number of matches.

2. The document comparison and identification method according to claim 1, wherein the predetermined number of characters is 6.

3. The document comparison and identification method according to claim 1, wherein the predetermined minimum required number of matches is calculated according to the formula:
M=Floor (((T−N)*X)+N)
wherein:
M is the minimum required number of matches;
T is the number of words in the list;
N is a constant coefficient;
X is a similarity ranking value; and
the number of identified words in the list is less than or equal to the constant coefficient.

4. The document comparison and identification method according to claim 3, wherein a document is determined to have high similarity with the source document if the number of identified words in the list occurring in the document is greater than, or equal to, the predetermined minimum required number of matches when X=0.9.

5. The document comparison and identification method according to claim 3, wherein a document is determined to have medium similarity with the source document if the number of identified words in the list occurring in the document is greater than, or equal to, the predetermined minimum required number of matches when X=0.7.

6. The document comparison and identification method according to claim 3, wherein a document is determined to have low similarity with the source document if the number of identified words in the list occurring in the document is greater than, or equal to, the predetermined minimum required number of matches when X=0.5.

7. The document comparison and identification method according to claim 1, wherein the document is determined not to be similar with the source document if the number of identified words in the list occurring in the document is less than the predetermined minimum required number of matches when X=0.5.

8. The document comparison method according to claim 1, wherein the predetermined minimum required number of matches is equal to the number of identified words in the list.

9. A document comparison and identification method, comprising the steps of:
performing a first search to identify documents identical to a source document;
performing a second search to identify documents having an identical or a similar document name to the source document;
performing a third search to identify documents of similar content to the source document;
determining a ranking for the results of each of the first, second, and third searches; and
presenting results of the first, second, and third searches in accordance with the determined ranking.

10. The document comparison and identification method according to claim 9, wherein the documents identified by the first and second searches are deemed to have a high similarity ranking.

11. The document comparison and identification method according to claim 9, wherein the third search comprises identifying, in a source document, words of a predetermined number of characters or greater;
generating a list containing the identified words, and excluding identified words from said list that occur with a predetermined frequency or greater in a set of documents to be searched;
searching each of the plurality of documents in the set of documents for occurrences of the identified words stored in the list;
for each of the plurality of documents, determining how many identified words from the list occur in the document: and
calculating a similarity of each of the plurality of documents to the source document based on the total number of identified words in the list, the number of identified words in the list occurring in the document, and a predetermined minimum required number of matches.

12. The document comparison and identification method according to claim 11, wherein the similarity of documents identified by the third search is determined in accordance with the formula:
M=Floor (((T−N)*X)+N)
wherein:
M is the minimum required number of matches;
T is the number of words in the list;
N is a constant coefficient; and
X is a similarity ranking value; and
the number of identified words in the list is less than or equal to the constant coefficient.

13. A document comparison and identification apparatus comprising:
a memory unit for storing data and program instructions; and
a processing unit coupled to said memory unit;
wherein said processing unit is programmed to:
identify, in a source document, words of a predetermined number of characters or greater;
generate a list containing the identified words, and exclude identified words from the list that occur with a predetermined frequency or greater in a set of documents to be searched;
search each of the plurality of documents in the set of documents for occurrences of the identified words stored in the list;
determine, for each of the plurality of documents, how many identified words from the list occur in the document; and
calculate a similarity of each of the plurality of documents to the source document based on the total number of identified words in the list, the number of identified words in the list occurring in the document, and a predetermined minimum required number of matches.

14. The document comparison and identification apparatus according to claim 13, wherein the processing unit is programmed to calculate the predetermined minimum required number of matches according to the formula:
M=Floor (((T−N)*X)+N)
wherein:
M is the minimum required number of matches;
T is the number of words in the list;
N is a constant coefficient;
X is a similarity ranking value; and
the number of identified words in the list is less than or equal to the constant coefficient.

15. The document comparison apparatus according to claim 13, wherein the predetermined minimum required number of matches is equal to the number of identified words in the list.

16. A document comparison and identification apparatus, comprising:
a memory unit for storing data and program instructions; and
a processing unit coupled to said memory unit;
wherein said processing unit is programmed to:
perform a first search to identify documents identical to a source document;
perform a second search to identify documents having an identical or a similar document name to the source document;
perform a third search to identify documents of similar content to the source document;
determine a ranking for the results of each of the first, second, and third searches; and
present results of the first, second, and third searches in accordance with the determined ranking.

17. The document comparison and identification apparatus according to claim 16, wherein for performing the third search, the processing unit is programmed to:
identify, in a source document, words of a predetermined number of characters or greater;
generate a list containing the identified words, and exclude identified words from the list that occur with a predetermined frequency or greater in a set of documents to be searched;
search each of the plurality of documents in the set of documents for occurrences of the identified words stored in the list;
determine, for each of the plurality of documents, how many identified words from the list occur in the document; and
calculate a similarity of each of the plurality of documents to the source document based on the total number of identified words in the list, the number of identified words in the list occurring in the document, and a predetermined minimum required number of matches.

18. The document comparison and identification apparatus according to claim 17, wherein the processing unit is programmed to calculate the predetermined minimum required number of matches in accordance with the formula:
M=Floor (((T−N)*X)+N)
wherein:
M is the minimum required number of matches;
T is the number of words in the list;
N is a constant coefficient;
X is a similarity ranking value; and
the number of identified words in the list is less than or equal to the constant coefficient.

19. A computer program product comprising a computer readable medium comprising a computer program recorded therein for document comparison and identification, said computer program product comprising:
computer program code means for identifying, in a source document, words of a predetermined number of characters or greater;
computer program code means for generating a list containing the identified words, and excluding identified words from said list that occur with a predetermined frequency or greater in a set of documents to be searched;
computer program code means for searching each of the plurality of documents in the set of documents for occurrences of the identified words stored in the list;
computer program code means for, for each of the plurality of documents, determining how many identified words from the list occur in the document; and
computer program code means for calculating a similarity of each of the plurality of documents to the source document based on the total number of identified words in the list, the number of identified words in the list occurring in the document, and a predetermined minimum required number of matches.

20. A computer program product comprising a computer readable medium comprising a computer program recorded therein for document comparison and identification, said computer program product comprising:
computer program code means for performing a first search to identify documents identical to a source document;
computer program code means for performing a second search to identify documents having an identical or a similar document name to the source document;
computer program code means for performing a third search to identify documents of similar content to the source document;
computer program code means for determining a ranking for the results of each of the first, second, and third searches; and
presenting results of the first, second, and third searches in accordance with the determined ranking.

21. A computer program product according to claim 20, wherein said computer program code means for performing a third search comprises:
computer program code means for identifying, in a source document, words of a predetermined number of characters or greater;
computer program code means for generating a list containing the identified words, and excluding identified words from said list that occur with a predetermined frequency or greater in a set of documents to be searched;
computer program code means for searching each of the plurality of documents in the set of documents for occurrences of the identified words stored in the list;
computer program code means for each of the plurality of documents, determining how many identified words from the list occur in the document; and
computer program code means for calculating a similarity of each of the plurality of documents to the source document based on the total number of identified words in the list, the number of identified words in the list occurring in the document, and a predetermined minimum required number of matches.
